(19) United States
(12) Patent Application Publication
(10) Pub. No.: US 2007/0211029 A1
(43) Pub. Date: Sep. 13, 2007

(54) Wireless mouse

(75) Inventors: Hsiao-Lung Chiang, Taipei (TW); Ming-Hsun Lu, Taipei (TW); Hong-Che Yen, Taipei (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Primax Electronics Ltd.

(21) Appl. No.: 11/433,085

(22) Filed: May 12, 2006

(30) Foreign Application Priority Data
Mar. 7, 2006 (TW) 095107509

(51) Int. Cl. G09G 5/08

(52) U.S. Cl. 345/163

(57) ABSTRACT

A wireless mouse includes a lower housing, a carrier, a battery cover, an elastic element, a first conductive piece and a second conductive piece. The lower housing receives therein a circuit board. The carrier is disposed above the circuit board and has a receptacle for accommodating a battery therein. The battery cover is used for sheltering a portion of the carrier and is pivotal relative to the carrier. The elastic element is disposed on the carrier for providing an upward elastic force on the battery cover. The first conductive piece is fixed on the battery cover and has a first connecting part. The second conductive piece is connected to the circuit board and includes a second connecting part and a button part, wherein the first conductive piece is in contact with the second connecting part of the second conductive piece when the battery cover is closed.

### FIELD OF THE INVENTION

The present invention relates to a wireless mouse, and more particularly to a wireless mouse having a pivotable battery cover.

### BACKGROUND OF THE INVENTION

Wireless mice have experienced great growth and are rapidly gaining in popularity because no signal wires are required when they are operated

During operation, wireless signals are transmitted between a wireless mouse and a computer system such that no additional signal wire is necessary. When a wireless mouse is designed, the power source for the wireless mouse should be taken into consideration.

For most wireless mice, batteries are used as the power source. Generally, the conventional wireless mouse has a space in the bottom thereof for accommodating one or more batteries. The bottom of the wireless mouse further comprises a battery cover for facilitating fixture of the battery within the receptacle. If the user intends to replace the battery, the battery cover should be detached from the housing of the wireless mouse so as to replace the battery with a new one.

Since the battery cover and the housing of the wireless mouse are separate elements, the probability of falling down or losing the battery cover is increased when the battery cover is detached.

For solving the problem of falling down or losing the battery cover, a wireless mouse having a pivotable type battery cover is disclosed in Taiwanese Patent Gazette No. M262769, which was filed on Jun. 17, 2004 and entitled “Rotary structure of mouse cover”.

Referring to FIG. 1, a schematic perspective view of a mouse disclosed in Taiwanese Patent Gazette No. M262769 is illustrated. The mouse of FIG. 1 comprises a battery cover 20, which is coupled to a housing of the mouse. After the battery cover 20 is uplifted, the batteries 142 can be removed from the wireless mouse for replacement. After the batteries are replaced with new ones, the battery cover 20 is pressed down to shelter the batteries. Since the battery cover 20 is coupled to the housing, the problem of losing the battery cover is avoided.

In addition to the battery cover, the traces or conductive pieces for interconnecting the batteries with the circuit board (not shown) inside the housing are also important as electric conduction elements of the battery to transmit electricity to the mouse.

As previously described, when compared with the wired mouse, the wireless mouse is advantageous because no additional signal wire is necessary. Unfortunately, for designing the battery cover and the electric conduction loop of the battery, the complexity of the wireless mouse is increased. Therefore, it is needed to provide a wireless mouse having simplified battery cover and electric conduction loop.

In views of the above-described disadvantages resulted from the prior art, the applicant keeps on carving unflaggingly to develop an improved wireless mouse according to the present invention through wholehearted experience and research.

### SUMMARY OF THE INVENTION

It is an object of the present invention to provide a wireless mouse having a pivotable battery cover, in which the hooking structure of the battery cover has the functions of making electric conduction and hooking on the housing.

In accordance with an aspect of the present invention, there is provided a wireless mouse. The wireless mouse comprises a lower housing, a carrier, a battery cover, an elastic element, a first conductive piece and a second conductive piece. The lower housing receives therein a circuit board. The carrier is disposed above the circuit board and has a receptacle for accommodating a battery therein. The battery cover is used for sheltering a portion of the carrier and is pivotal relative to the carrier. The elastic element is disposed on the carrier for providing an upward elastic force on the battery cover. The first conductive piece is fixed on the battery cover and has a first connecting part. The second conductive piece is connected to the circuit board and includes a second connecting part and a button part, wherein the first conductive piece is in contact with the second connecting part of the second conductive piece when the battery cover is closed.

In an embodiment, the first connecting part includes a hooking element, and the second connecting part includes an elastic part and a lock hole.

In an embodiment, the wireless mouse further comprises an upper housing for sheltering the remaining portion of the carrier unsheltered by the battery cover.

In an embodiment, the battery cover further comprises a shaft member, which is disposed on opposite side of the first conductive piece.

In an embodiment, the elastic element has two elastic arms fixed onto the shaft member.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view of a mouse having a pivotable battery cover;

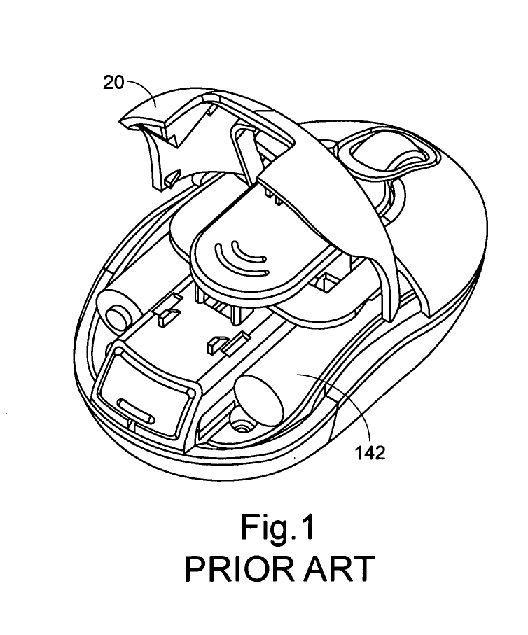

FIG. 2 is a schematic exploded view of a wireless mouse according to a preferred embodiment of the present invention;

FIG. 3 schematically illustrates a combination of the elastic element and the batter cover;

FIG. 4 is a schematic assembled view of the wireless mouse of FIG. 2; and

FIG. 5 schematically illustrates an electric conduction loop between the first conductive piece, the second conductive piece and the circuit board.

### DETAILED DESCRIPTION OF THE PREFERRED EMBODIMENT

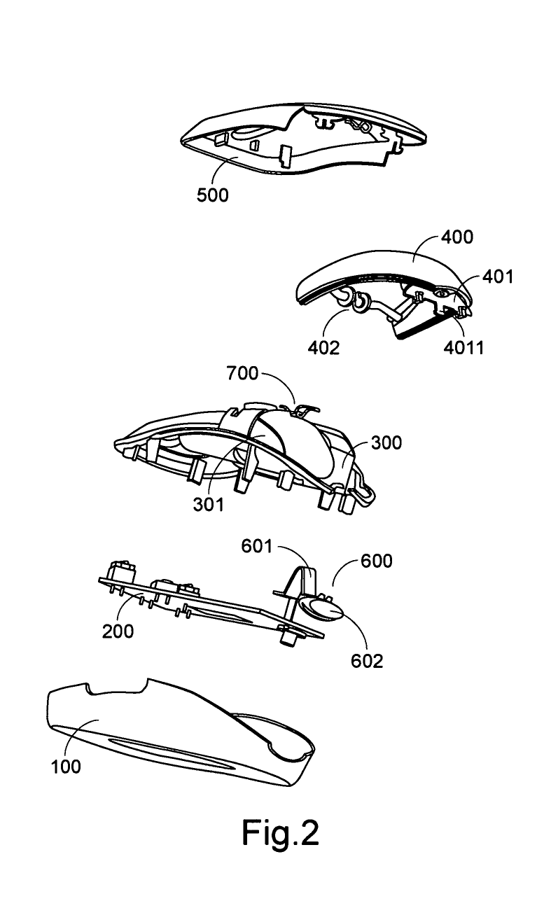

Referring to FIG. 2, a schematic exploded view of a wireless mouse according to a preferred embodiment of the present invention is illustrated. the wireless mouse as shown in FIG. 2 comprises a lower housing 100, a circuit board 200, a carrier 300, a battery cover 400, an upper housing 500, a second conductive piece 600 and an elastic element 700. The battery cover 400 includes a first conductive piece 401 and a shaft member 402. The carrier 300 has therein two receptacles 301. The first conductive piece 401 has a first connecting part such as a hooking element 4011. The second conductive piece 600 includes a second connecting part and a button part 602. In this embodiment, the second connecting part includes an elastic part 601 and a lock hole 603.

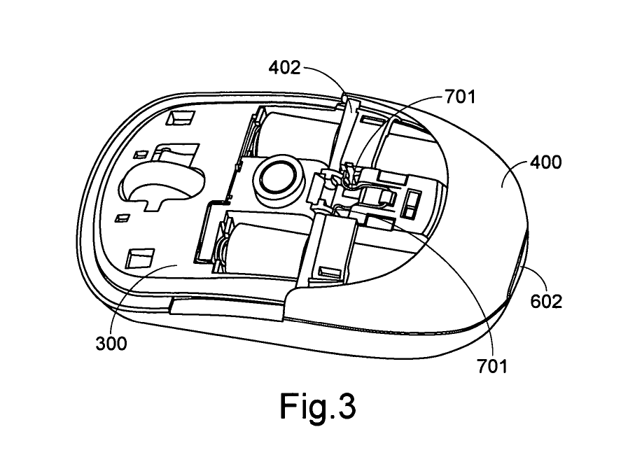

Please refer to FIG. 2 again. The circuit board 200 and the carrier 300 are received in the lower housing 100. The carrier 300 is sheltered by the upper housing 500 and the battery cover 400. On the circuit board 200, there are several electronic components required for operation of the wireless mouse. The carrier 300 has receptacles 301 for receiving batteries therein. The battery cover 400 is mounted on the carrier 300 and pivotal about the shaft member 402. The elastic element 70 is fixed on the carrier 300 and includes two elastic arms 701, which are fixed onto the shaft member 402 of the battery cover 400. Please refer to FIG. 3, which schematically illustrates a combination of the elastic element 70 and the batter cover 400. For clarity and neat drawing, however, the upper housing 500 is omitted in FIG. 3.

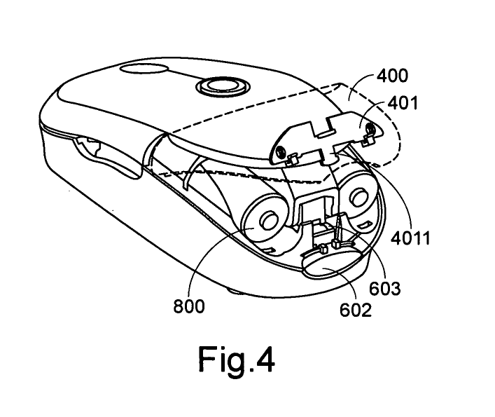

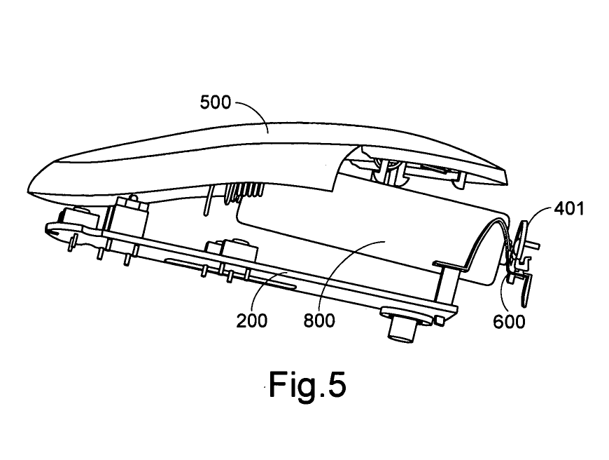

Referring to FIG. 4, a schematic assembled view of the wireless mouse of FIG. 2 is illustrated. Please refer to FIG. 4 and also FIG. 2. When the user intends to close the battery cover 400, the battery cover 400 should be pressed down such that the hooking element 4011 of first conductive piece 401 mounted on the battery cover 400 is penetrated through the lock hole 603 of the second conductive piece 600 and then engaged with the second conductive piece 600. After the battery cover 400 is closed, the first conductive piece 401 is in contact with the conductive electrodes of the batteries 800. Since the second conductive piece 600 is also electrically connected to the circuit board 300, an electric conduction loop between the batteries and the circuit board 300 is formed, as is shown in FIG. 5.

When the user intends to open the battery cover 400, the user may push the button part 602 of the second conductive piece 600. In response to the pushing force applied on the button part 602, the elastic part 601 is pushed forward and thus the hooking element 4011 is disengaged from the lock hole 603. As a result, the battery cover 400 is detached from the second conductive piece 600 and uplifted due to the elastic force of the elastic element 700. Meanwhile, the batteries 800 are revealed, and thus the user can replace the batteries 800 with new ones.

From the above description, since the hooking element is integrated with the first conductive piece and mounted on the battery cover, the electric conduction loop between the batteries and the circuit board will be formed when the battery cover is closed. Therefore, no additional conductive structure for the battery is necessary. In addition, since the hooking element is made of conductive material such as metallic material, a more secure attachment between the hooking element and the lock hole is provided when compared with the plastic hooking element.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A wireless mouse comprising:
a lower housing receiving therein a circuit board;
a carrier disposed above said circuit board and having a receptacle for accommodating a battery therein;
a battery cover for sheltering a portion of said carrier and pivotal relative to said carrier;
an elastic element disposed on said carrier for providing an upward elastic force on said battery cover;
a first conductive piece fixed on said battery cover and having a first connecting part; and
a second conductive piece connected to said circuit board and including a second connecting part and a button part, wherein said first conductive piece is in contact with said second connecting part of said second conductive piece when said battery cover is closed.

2. The wireless mouse according to claim 1 wherein said first connecting part includes a hooking element, and said second connecting part includes an elastic part and a lock hole.

3. The wireless mouse according to claim 1 further comprising an upper housing for sheltering the remaining portion of said carrier unsheltered by said battery cover.

4. The wireless mouse according to claim 1 wherein said battery cover further comprises a shaft member, which is disposed on opposite side of said first conductive piece.

5. The wireless mouse according to claim 4 wherein said elastic element has two elastic arms fixed onto said shaft member.
